(19) United States
(12) Patent Application Publication
(10) Pub. No.: US 2004/0211366 A1
(43) Pub. Date: Oct. 28, 2004

(54) Apparatuses useful for watering pets

(75) Inventors: Joseph M. Jarke, Austin, TX (US); Keith H. Gausmann, Westerville, OH (US); Jeffrey W. Mulhausen, Austin, TX (US)

Correspondence Address: FULBRIGHT & JAWORSKI L.L.P., 600 CONGRESS AVE., SUITE 2400, AUSTIN, TX, 78701, US

(73) Assignee: RJ Product Development Inc.

(21) Appl. No.: 10/750,994

(22) Filed: Jan. 2, 2004

Related U.S. Application Data
(60) Provisional application No. 60/437,673, filed on Jan. 2, 2003.

(51) Int. Cl. A01K 7/00

(52) U.S. Cl. 119/75; 119/72

(57) ABSTRACT

Apparatuses that are removably attached to containers that can be used to water pets. The containers can take the form of standard water bottles. An embodiment of the apparatuses includes a base cap removably attachable to such a container, the base cap having a base cap flow aperture; and a flow activation member removably attachable to the base cap, the flow activation member having a triggering mechanism and a flow activation member flow aperture. Other embodiments are included.

### CROSS-REFERENCE(S) TO RELATED APPLICATION(S)

This application claims priority to U.S. Provisional Patent Application Ser. No. 60/437,673, filed Jan. 2, 2003, the entire contents of which are expressly incorporated by reference.

### BACKGROUND OF THE INVENTION

1. Field of the Invention

The present invention relates generally to devices from which pets can drink. More particularly, it relates to a liquid flow cap that can be attached to a container, such as a standard water bottle, so that pets can drink liquid flowing from the container.

2. Description of Related Art

Conventional pet watering devices generally fall into categories of bowls, tanks, and lick systems. Most of these devices provide for the storage of water as well as access by pets to the water.

Bottled water has become popular. Many stores offer bottles that contain a few ounces of water and that are conveniently designed for individual use. Many drinks besides water can be purchased in the same types of containers. Energy drinks, fruit juices, soft drinks, and others can all be obtained in bottles that are generally plastic and provided with screw tops of some kind.

### SUMMARY OF THE INVENTION

The present invention comprises an apparatus that can be attached to a container that carries liquid—such as a standard water bottle—such that pets can effectively drink from the container. As a result, the present apparatuses allow for existing water bottles and other fluid containers to be converted into pet fluid storage containers.

One embodiment of the present apparatuses comprises an apparatus attachable to a container useful for watering an animal. The apparatus includes a base cap removably attachable to the container. The base cap has a base cap flow aperture. The apparatus also includes a flow activation member removably attachable to the base cap. The flow activation member has a triggering mechanism and a flow activation member flow aperture. Other embodiments, and details associated with those embodiments, are described below.

It is anticipated that most of the liquid containers to which the present apparatuses can be attached will be water bottles with threaded tops. The present apparatuses can be used to replace the caps that are otherwise sold with such bottles. Attachment mechanisms other than threads also may be used on such bottles. The base caps of the present apparatuses can be configured to work with such attachment mechanisms. Once one of the present apparatuses is attached to a liquid container, a pet can activate the apparatus to start the flow of liquid. In one embodiment, the activator, or triggering mechanism, is a lever that extends away from the bottle. It is anticipated that a pet will lick the lever, causing one or more apertures in the apparatus to open, and allowing liquid to flow from the container. An outer cap also may be used that will allow a human user to place the apparatus in an activated state, or a deactivated state.

### BRIEF DESCRIPTION OF THE DRAWINGS

The following drawings illustrate by way of example and not limitation. The use of identical reference numerals does not necessarily indicate an identical structure. Rather, the same reference numeral may be used to indicate a similar feature or a feature with similar functionality. Reference numerals should not be used to construe the claims.

FIG. 1 is an exploded perspective view of one embodiment of the present apparatuses.

FIG. 2 is a side view of the embodiment of the present apparatuses shown in FIG. 1.

FIG. 3 is a top view of the embodiment of the present apparatuses shown in FIG. 1.

FIG. 4 is a perspective view showing of the embodiment of the present apparatuses shown in FIG. 1 attached to a container (e.g., a bottle).

### DETAILED DESCRIPTION OF ILLUSTRATIVE EMBODIMENTS

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, an element of an apparatus that “comprises,” “has,” or “includes” one or more features possesses those one or more features, but is not limited to possessing only those one or more features.

Thus, and by way of example, an apparatus that is attachable to a container useful for watering an animal, the apparatus “comprising” a base cap removably attachable to the container, the base cap having a base cap flow aperture; and a flow activation member removably attachable to the base cap, the flow activation member having a triggering mechanism and a flow activation member flow aperture, is an apparatus that has, but is not limited to having only, such a base cap and such a flow activation member. That is, the apparatus possesses at least the recited base cap and flow activation member, but does not exclude other elements or features that are not expressly recited, such as, for example, an outer cap. Likewise, the recited base cap, for example, may also possess unrecited features, such as additional base cap flow apertures.

The terms “a” and “an” are defined as one or more than one unless this disclosure explicitly requires otherwise.

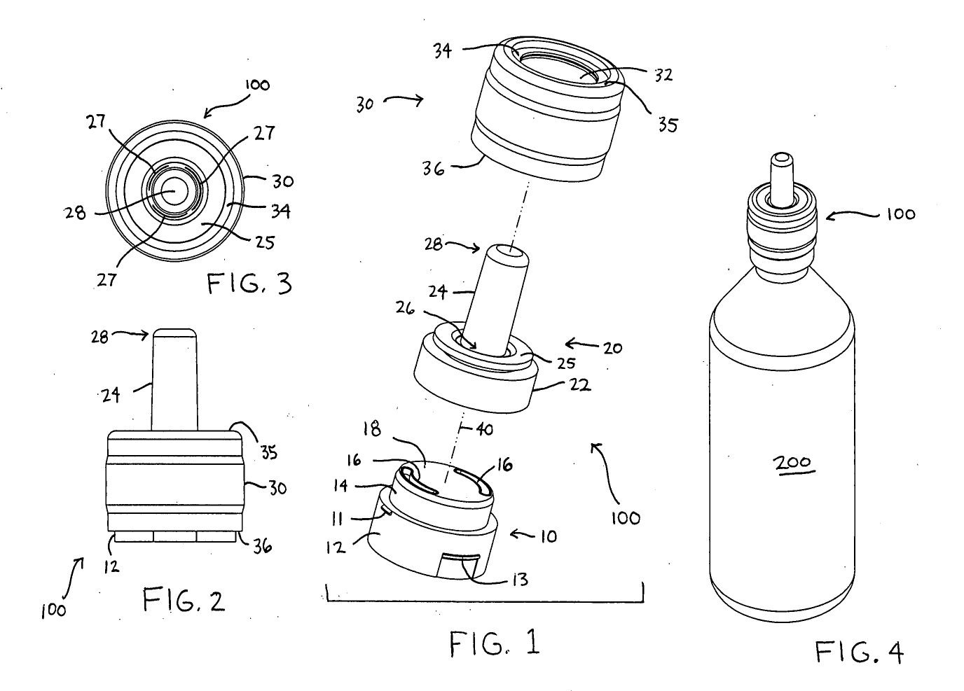

FIG. 1 illustrates one embodiment of the present apparatuses. Liquid flow cap 100 includes base cap 10. Base cap 10 includes an attachment section 12 and an extension member 14, both of which can be cylindrical in shape, as shown. Attachment section 12 and extension member 14 also can both be hollow. Attachment section 12 may be threaded such that base cap 10 can be removably attached to a container that is provided with a threaded top. “Removably attachable” is defined such that a first device that is “removably attachable” to a second device can be attached to the second device and then removed from it without breaking or destroying the utility of either the first or second device. In other embodiments, base cap 10 may be provided with an attachment mechanism other than a thread in order to best suit the container to which the base cap will be attached.

Base cap 10 also includes top 18 and a base cap flow aperture 16. More particularly, top 18 of base cap 10 includes multiple base cap flow apertures 16 that have any suitable shape. When the embodiment of base cap 10 shown in FIG. 1 is removably attached to a container, fluid can flow from the container through base cap flow apertures 16. Base cap 10 can be made from any suitable material—such as polymer (e.g., plastic or a plastic-like material) or metal—and can be generally rigid.

Liquid flow cap 100 also includes flow activation member 20 that is removably attachable to base cap 10. One way in which flow activation member 20 may be removably attached to base cap 10 is through the use of outer cap 30, discussed in more detail below. The depicted embodiment of flow activation member 20 includes a sealing member 22 that is cylindrical in shape and configured (e.g., sized) to fit snugly over a portion of base cap 10, namely extension member 14. By virtue of such a fit and the material properties of flow activation member 20, liquid should not be able to flow through base cap flow apertures 16 and then leak out between extension member 14 and sealing member 22.

Flow activation member 20 also includes triggering mechanism 24, which is a lever in this embodiment. Lever 24 includes a base 26 at which it is attached to (in this case integrally with) sealing member 22, and a tip 28. Lever 24 is cylindrical in shape (although any suitable shape may be used) and extends outwardly from sealing member 22 and base cap 10. Lever 24 may be hollow or solid. An axis 40 is substantially centered in lever 24 and the remainder of liquid flow cap 100. This embodiment of flow activation member 20 also includes a washer 25 that extends from sealing member 22 and surrounds lever 24. Washer 25, lever 24, and sealing member 22 all may be integrally formed from a unitary piece of material.

Flow activation member 20 also includes one or more flow activation member flow apertures 27 (e.g., slots, and visible in FIG. 3) positioned between lever 24 and washer 25. In this embodiment, the flow activation member flow apertures are positioned in sealing member 22. The flow activation member flow apertures are substantially sealed when lever 24 is in a deactivated position (i.e., the centered position shown in FIG. 1). The term “substantially” is defined as at least close to (and can include) a given value or state (preferably within 10% of, more preferably within 1% of, and most preferably within 0.1% of). Such sealing may be achieved by making the apertures slits or narrow slots, and by virtue of the elastic properties of the material from which flow activation member 20 is made.

The flow activation member flow apertures can be positioned in flow activation member 20 such that, when outer cap 30 is not used or in an activated positioned, more liquid can pass through them when lever 24 is in an activated positioned (e.g., flexed—disposed to one side, or pushed off center) than when lever 24 is in its deactivated position. For example, when outer cap 30 is an activated position and lever 24 is then activated, liquid can flow through base cap flow apertures 16 and through flow activation member flow apertures 27. Further, the liquid may flow along lever 24 by virtue of surface tension, thus helping to deliver the liquid in a controlled fashion to the pet. When the lever returns to its normal, or deactivated position, the flow activation member flow apertures are sealed, inhibiting the flow of liquid. Flow activation member 20 may be made from rubber, or a rubber-like material.

Liquid flow cap 100 may also include outer cap 30, which is cylindrical in shape in this embodiment and removably attachable to base cap 10. Outer cap 30 is configured to fit over at least a portion of base cap 10 (in the embodiment shown, that portion includes both a portion of attachment section 12 and extension member 14) and a portion of flow activation member 20 (in the embodiment shown, that portion includes all of flow activation member 20). Outer cap 30 has lever aperture 32 through which lever 24 can pass (see, e.g., FIGS. 2 and 3). Lever aperture 32 is defined by shoulder 34, which projects inwardly from an upper portion of outer cap 30. In this embodiment, shoulder 34 is recessed from top edge 35 of outer cap 30.

The removable attachability between outer cap 30 and base cap 10 may be achieved by providing base cap 10 with a tab snap assembly 11 (which includes one or more male tab snaps) and one or more stop tabs 13. The inner surface of outer cap 30 may be configured to work with (e.g., engage) tab snap assembly 11 and stop tabs 13. Moreover, that configuration may be such that outer cap 30 is capable of having an outer cap deactivated position and one or more outer cap activated positions. Shoulder 34 can be urged against washer 25 of flow activation member 20 in order to close flow activation member flow apertures 27 despite movement of lever 24. When base edge 36 of outer cap 30 is moved away from a container to which base cap 10 is removably attached, and shoulder 34 is positioned so as not to contact washer 25, flow activation member flow apertures 27 are free to open when lever 24 is activated. Thus, when outer cap 30 is in an outer cap activated position, lever 24 can be moved by a pet and liquid can flow from the container through the base cap flow apertures and flow activation member flow apertures to the pet. If the outer cap is in the outer cap deactivated position, shoulder 34 is urged against washer 25 and liquid is not allowed to flow out of the container. Outer cap 30 can be made of any suitably rigid material, such as plastic or a plastic-like material.

FIG. 2 is a side view of an embodiment of liquid flow cap 100, showing outer cap 30 removably attached to base cap 10 and positioned over portions of base cap 10 and flow activation member 20.

FIG. 3 is a top view of an embodiment of liquid flow cap 100, and shows the orientation of outer cap 30, shoulder 34 of outer cap 30, washer 25 of flow activation member 20, and flow activation member flow apertures 27 of flow activation member 20.

FIG. 4 illustrates an embodiment of liquid flow cap 100 removably attached to a container 200 that is useful for watering an animal. In this embodiment, container 200 is a standard water bottle.

With the present apparatuses, pets can be watered in a number of situations conveniently. For example, a user may engage in some form of physical activity such as jogging or biking, take a water bottle with liquid flow cap 100 removably attached to it, and be able to water an accompanying pet when desirable. The outer cap can be used to assure the user that the contained liquid will not accidentally be lost during the activity. In order to use the liquid flow cap, the user can move the outer cap to an activated position and extend the bottle to the pet. Once the pet is aware of its ability to obtain water or other liquid from the bottle by licking or otherwise moving the lever, it can do so whenever given a chance by the user.

It should be understood that the present apparatuses are not intended to be limited to the particular forms disclosed. Various modifications of the disclosed embodiments, as well as alternative embodiments of the present apparatuses, will become apparent to persons of ordinary skill in the art upon reference to the description above. The present apparatuses are to cover all modifications, equivalents, and alternatives falling within the scope of the claims. Furthermore, the claims are not to be interpreted as including means-plus- or step-plus-function limitations, unless such a limitation is explicitly recited in a given claim using the phrase(s) “means for” or “step for,” respectively.

1. An apparatus attachable to a container useful for watering an animal, the apparatus comprising:
a base cap removably attachable to the container, the base cap having a base cap flow aperture; and
a flow activation member removably attachable to the base cap, the flow activation member having a triggering mechanism and a flow activation member flow aperture.

2. The apparatus of claim 1, where the apparatus further comprises:
an outer cap removably attachable to the base cap, the outer cap having an aperture through which the triggering mechanism can pass.

3. The apparatus of claim 1, where the base cap is threaded.

4. The apparatus of claim 1, where the base cap includes multiple base cap flow apertures.

5. The apparatus of claim 4, where the flow activation member includes multiple flow activation member flow apertures.

6. An apparatus attachable to a container useful for watering an animal, the apparatus comprising:
a base cap removably attachable to the container, the base cap having a base cap flow aperture; and
a flow activation member configured to fit over a portion of the base cap and being removably attachable to the base cap, the flow activation member having a lever and a flow activation member flow aperture, the lever having a deactivated position and an activated position.

7. The apparatus of claim 6, where the apparatus further comprises:
an outer cap removably attachable to the base cap, the outer cap having a lever aperture through which the lever can pass, the outer cap also being configured to fit over a portion of the base cap and a portion of the flow activation member; and
where the base cap is threaded.

8. The apparatus of claim 7, where the base cap includes multiple base cap flow apertures, and the flow activation member includes multiple flow activation member flow apertures.

9. An apparatus attachable to a container useful for watering an animal, the apparatus comprising:
a base cap removably attachable to the container, the base cap having a base cap flow aperture; and
a flow activation member configured to fit over a portion of the base cap and being removably attachable to the base cap, the flow activation member having a lever, a washer surrounding the lever, and a flow activation member flow aperture, the lever having a deactivated position and an activated position.

10. The apparatus of claim 9, where the apparatus further comprises:
an outer cap removably attachable to the base cap, the outer cap having a lever aperture through which the lever can pass, the lever aperture being defined by a shoulder that projects inwardly from a portion of the outer cap, the outer cap also being configured to fit over a portion of the base cap and a portion of the flow activation member, the outer cap having an outer cap deactivated position and an outer cap activated position; and
where the flow activation member flow aperture is positioned in the flow activation member such that, when the outer cap is in the outer cap activated position, more liquid can pass through the flow activation member flow aperture when the lever is in the activated position than when the lever is in the deactivated position.

11. The apparatus of claim 10, where the base cap includes multiple base cap flow apertures, and the flow activation member includes multiple flow activation member flow apertures.
